(19) United States
(12) Patent Application Publication
(10) Pub. No.: US 2026/0338235 A1
(43) Pub. Date: Oct. 29, 2026

(54) Power Transmission Shaft and Propeller Shaft

(71) Applicant: Hitachi Astemo, Ltd., Hitachinaka-shi, Ibaraki (JP)

(72) Inventors: Sha LI, Hitachinaka-shi, Ibaraki (JP); Yasushi AKITA, Hitachinaka-shi, Ibaraki (JP); Kento HARUNA, Hitachinaka-shi, Ibaraki (JP)

(21) Appl. No.: 19/110,654

(22) PCT Filed: Aug. 1, 2023
(86) PCT No.: PCT/JP2023/028043

§ 371 Date: Mar. 11, 2025

(30) Foreign Application Priority Data
Sep. 12, 2022 (JP) 2022-144267

(51) Int. Cl. F16D 1/072; F16C 3/02; F16D 3/38

(52) U.S. Cl. CPC F16D 1/072; F16C 3/023; F16C 3/026; F16D 3/387; F16C 2226/12; F16C 2226/80; F16C 2326/06

(57) ABSTRACT

A propeller shaft (PS1) as a propeller shaft according to the present invention is configured so that when a second collision load (F2), which is greater than a first collision load (F1) by which a fixed state between a first inserting portion (22) and a tube (1) is released, acts, a fixed state between a second inserting portion (32) and the tube (1) is released. Therefore, upon collision of a vehicle, i.e. when an axial direction load (Fx) acts on the propeller shaft (PS1), the fixed state of the first inserting portion (22) is released earlier than the second inserting portion (32). It is thus possible to control an order of the fixation release of the first inserting portion (22) and the second inserting portion (32) to the tube (1), thereby improving stability of collision performance of the propeller shaft (PS1).

### TECHNICAL FIELD

The present invention relates to a power transmission shaft and a propeller shaft.

### BACKGROUND ART

A conventional propeller shaft as a power transmission shaft disclosed in, for instance, the following Patent Document 1 has been known.

When describing an outline of this propeller shaft as the power transmission shaft briefly, a first joint member is press-fitted into an inner peripheral side of a first end portion of an FRP tube body as a tubular member through a first inserting portion having at its outer peripheral side a first serration part, and a second inserting portion having at its outer peripheral side a second serration part is press-fitted into an inner peripheral side of a second end portion of the FRP tube body.

### CITATION LIST

### Patent Document

Patent Document 1: Japanese Unexamined Patent Application Publication No. JP2000-329130

### SUMMARY OF THE INVENTION

### Technical Problem

In the case of above conventional propeller shaft, however, the first inserting portion and the second inserting portion having the first serration part and the second serration part which are the same shape are press-fitted into the first end portion and the second end portion of the FRP tube body respectively. Because of this, when a vehicle collides, it is difficult to predict which of the first end portion and the second end portion of the FRP tube body is first destroyed, i.e. which of the first inserting portion and the second inserting portion first penetrates into the FRP tube body. Therefore, there is room for improvement in that collision performance of the propeller shaft as the power transmission shaft becomes unstable.

The present invention was made in view of the above technical problem of the conventional propeller shaft. An object of the present invention is therefore to provide a power transmission shaft and a propeller shaft that are capable of improving stability of the collision performance.

### Solution to Problem

According to one aspect of the present invention, a second collision load that releases a fixed state between a tube and a second inserting portion is set to be greater than a first collision load that releases a fixed state between the tube and a first inserting portion.

### Effects of Invention

According to the present invention, it is possible to improve the stability of the collision performance.

### BRIEF DESCRIPTION OF THE DRAWINGS

FIG. 1 is a layout drawing showing an arrangement of a power transmission shaft according to the present invention in a vehicle.

FIG. 2 is a longitudinal cross section of the entire power transmission shaft according to a first embodiment of the present invention.

FIG. 3 is an enlarged sectional view of a main part, cut by a plane A-A in FIG. 2.

FIG. 4 is a modified example according to the present invention. FIG. 4 shows an enlarged cross section of a main part, cut by a plane A-A in FIG. 2.

FIGS. 5A to 5C are longitudinal cross sections of the power transmission shaft shown in FIG. 2, showing conditions of the power transmission shaft before and after occurrence of collapse. FIG. 5A shows a condition of the power transmission shaft in which the collapse has not occurred. FIG. 5B shows a condition of the power transmission shaft in which the collapse has occurred at a first end portion side of a tube. FIG. 5C shows a condition of the power transmission shaft in which the collapse has occurred at a second end portion side of the tube.

FIG. 6 is a longitudinal cross section of the entire power transmission shaft according to a second embodiment of the present invention.

FIG. 7 is a longitudinal cross section of the entire power transmission shaft according to a third embodiment of the present invention.

FIG. 8 is a longitudinal cross section of the entire power transmission shaft according to a fourth embodiment of the present invention.

FIGS. 9A and 9B are longitudinal cross sections of the power transmission shaft according to a fifth embodiment of the present invention. FIG. 9A is an enlarged view of a vicinity of the first end portion of the tube. FIG. 9B is an enlarged view of a vicinity of the second end portion of the tube.

FIG. 10 is a layout drawing showing another example of the arrangement of the power transmission shaft according to the present invention in the vehicle.

### EMBODIMENTS FOR CARRYING OUT THE INVENTION

Embodiments of a power transmission shaft according to the present invention will be described below with reference to the drawings. In the following embodiments, examples in which the power transmission shaft is applied as a propeller shaft for a vehicle, as in the conventional case, will be described.

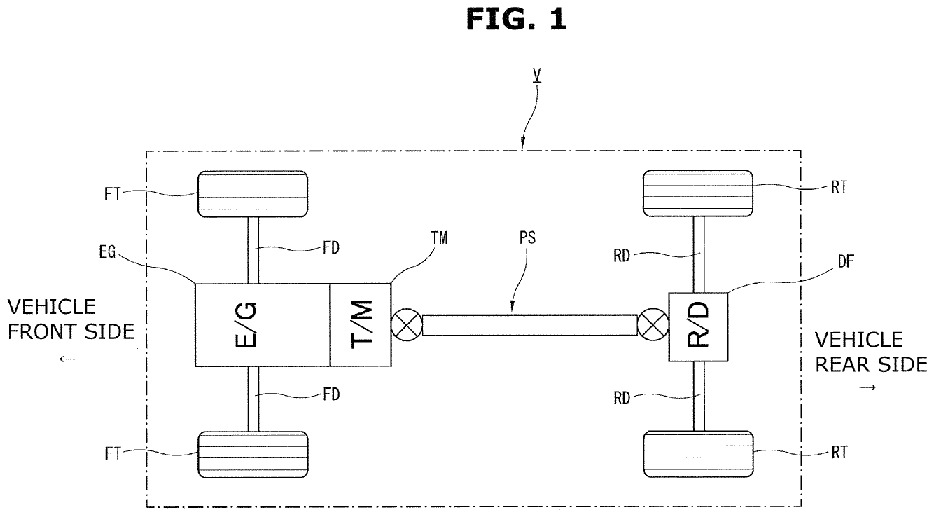

FIG. 1 is a layout drawing showing an arrangement of a power transmission shaft (a propeller shaft) according to the present invention in a vehicle.

As illustrated in FIG. 1, a vehicle V is a so-called FR (front-engine, rear-drive) vehicle. An engine EG and a transmission TM as a first power transmission device (a transmission device) that transmits a driving force of the engine EG are disposed on a front axle FD that connects front wheels FT. On the other hand, a differential gear DF as a second power transmission device (a differential device) that transmits power to a rear axle RD is disposed at a middle portion of the rear axle RD that connects rear wheels RT.

Then, the transmission TM and the differential gear DF are connected so as to be able to transmit power through a propeller shaft PS as the power transmission shaft.

### First Embodiment

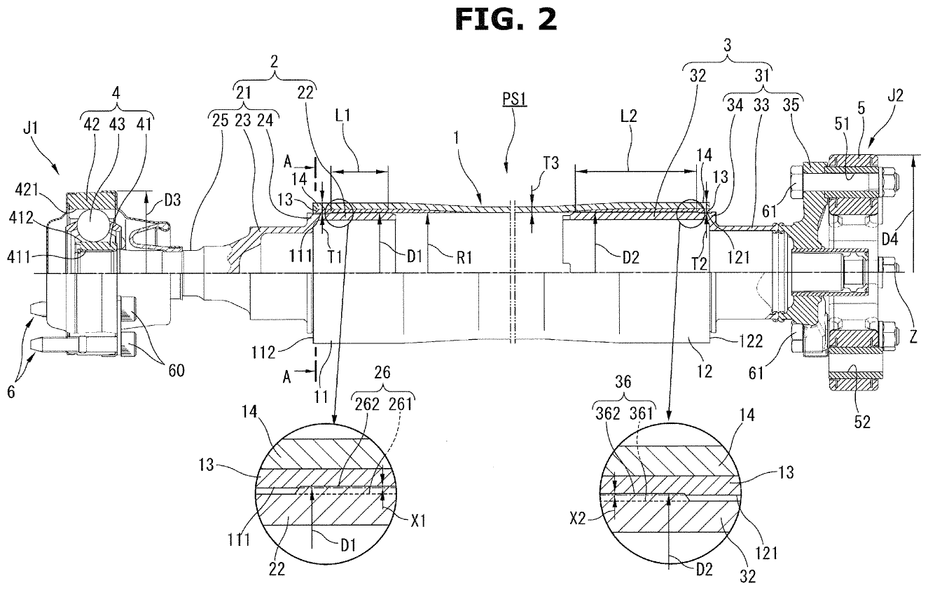

FIGS. 2 to 5 illustrate a first embodiment of the power transmission shaft according to the present invention. In the following description of the present embodiment, for the sake of convenience, a first joint member J1 side in FIG. 2 is referred to as a “front”, and a second joint member J2 side is referred to as a “rear”. Further, a direction along a rotation axis Z in FIG. 2 is referred to as an “axial direction”, a direction orthogonal to the rotation axis Z is referred to as a “radial direction”, and a direction of rotation about the rotation axis Z is referred to as a “circumferential direction”.

### Configuration of Propeller Shaft

FIG. 2 shows an entire propeller shaft PS1 according to the first embodiment of the present invention. FIG. 2 is a longitudinal cross section of the propeller shaft PS1, cut along the direction of the rotation axis Z.

As illustrated in FIG. 2, the propeller shaft PS1 is disposed between the first power transmission device (not shown) located at a vehicle front side and the second power transmission device (not shown) located at a vehicle rear side. As mentioned above, the first power transmission device corresponds to the transmission TM (see FIG. 1) as the transmission device, and the second power transmission device corresponds to the differential gear DF (see FIG. 1) as the differential device.

That is, the propeller shaft PS1 according to the present embodiment is a so-called one-piece structure propeller shaft, and a front end side of the propeller shaft PS1 is connected to the first power transmission device through the first joint member J1, and a rear end side of the propeller shaft PS1 is connected to the second power transmission device through the second joint member J2. That is, the propeller shaft PS1 has a tube 1 formed into a substantially cylindrical tubular shape, the first joint member J1 inserted into a first end portion 11 that is a front end portion of the tube 1 and serving to connect to the first power transmission device, and the second joint member J2 inserted into a second end portion 12 that is a rear end portion of the tube 1 and serving to connect to the second power transmission device.

It is noted that in the present embodiment, although an example in which the power transmission shaft (the propeller shaft) according to the present invention is applied to the one-piece structure propeller shaft having a single tube is described, the present invention can be applied to any propeller shaft as long as the propeller shaft has at least one tube and shaft joints that can collapse (described later) are connected to respective both axial direction end portions of the tube. In other words, the power transmission shaft (the propeller shaft) according to the present invention can also be applied to a multi-piece structure propeller shaft having a plurality of tubes and structured by connecting these tubes through shaft joints.

The tube 1 is made of a carbon fiber reinforced resin material (carbon fiber reinforced plastic) (a so-called CFRP), and formed into the cylindrical tubular shape having a constant inside diameter R1 in the axial direction. Further, the tube 1 is formed so that thicknesses T1 and T2 of the first end portion 11 and the second end portion 12 of the tube 1 are thicker than a thickness T3 of a normal portion (an axial direction middle portion) of the tube 1. More specifically, the tube 1 is integrally formed by laminating the carbon fiber reinforced resin material (CFRP) in the radial direction, and has at least two inner and outer layers of an inner peripheral layer 13 and an outer peripheral layer 14.

It is noted that in the present embodiment, although an example in which the tube 1 is made of the carbon fiber reinforced resin material (CFRP) is described, the tube 1 could be made of a fiber reinforced resin (fiber reinforced plastic) formed by solidifying fiber with resin, or may be made of e.g. a metal material. Further, in the case where the tube 1 is made of the fiber reinforced resin, in addition to the carbon fiber reinforced resin material (CFRP), the tube 1 could be made of e.g. a glass fiber reinforced resin (glass fiber reinforced plastic) (FRP).

The first joint member J1 has a first shaft portion 2 inserted into an inner peripheral portion 111 of the first end portion 11 of the tube 1, and a first joint portion 4 connecting the first shaft portion 2 and the first power transmission device. The first shaft portion 2 and the first joint portion 4 are fixed so as to be able to integrally rotate, and integrally formed as the first joint member J1.

The second joint member J2 has a second shaft portion 3 inserted into an inner peripheral portion 121 of the second end portion 12 of the tube 1, and a second joint portion 5 connecting the second shaft portion 3 and the second power transmission device. The second shaft portion 3 and the second joint portion 5 are fixed so as to be able to integrally rotate, and integrally formed as the second joint member J2.

The first shaft portion 2 has a first connecting base portion 21 exposed from the first end portion 11 of the tube 1 and connected to the first joint portion 4, and a first inserting portion 22 extending in the axial direction from a rear end portion of the first connecting base portion 21 and inserted into the inner peripheral portion 111 of the first end portion 11 of the tube 1. The first connecting base portion 21 and the first inserting portion 22 are formed integrally with each other with a metal material.

The first connecting base portion 21 has a first base portion 23, a first insertion-side connecting portion 24 formed into a step shape whose diameter is widened from a rear end portion of the first base portion 23 and connecting to the first inserting portion 22, and a first joint-side connecting portion 25 formed into a step shape whose diameter is reduced from a front end portion of the first base portion 23 and connecting to the first joint portion 4. Here, the first connecting base portion 21 and the first joint portion 4 form a first body portion of the present invention.

The first inserting portion 22 is inserted into the inner peripheral portion 111 of the first end portion 11 of the tube 1 through a predetermined engagement means (serrations in the present embodiment), and is fixed to the tube 1 so as to be able to rotate integrally with the tube 1. More specifically, a first serration part 26 that can be serration-connected to the tube 1 is formed throughout an almost entire area in the axial direction on an outer peripheral side of the first inserting portion 22.

The first serration part 26 is formed so that grooves 261 recessed inward in the radial direction are formed so as to extend in a direction parallel to the rotation axis Z, and an outside diameter D1 of each tooth tip 262 is set to be slightly larger than the inside diameter R1 of the tube 1. That is, the first inserting portion 22 is press-fitted into an inside of the first end portion 11 of the tube 1, and each tooth tip 262 bites into an inner peripheral surface of the tube 1, then the first serration part 26 makes the first inserting portion 22 engage with the tube 1 so as to be able to integrally rotate with the tube 1. With this, the first inserting portion 22 is supported in a fixed state at the inner peripheral portion 111 of the first end portion 11 of the tube 1 through the first serration part 26.

Here, a first collision load F1, which releases the fixed state between the first inserting portion 22 and the tube 1 and causes the first inserting portion 22 to start moving from the first end portion 11 toward the second end portion 12 at the inner peripheral portion of the tube 1, is set between the first serration part 26 and the tube 1. Then, in the present embodiment, the first collision load F1 is set based on a first biting length L1 that is a biting length (a tooth width) of the first serration part 26 engaging with (biting into) the inner peripheral portion 111 of the first end portion 11 of the tube 1.

The first joint portion 4 is formed by a universal joint (for instance, a constant-velocity joint in the present embodiment). The first joint portion 4 is provided at an opposite side to the tube 1 in the axial direction with respect to the first shaft portion 2. The first joint portion 4 has a substantially cylindrical inner ring member 41 fixed to an outer peripheral surface of the first joint-side connecting portion 25 of the first shaft portion 2, a substantially cylindrical outer ring member 42 arranged at an outer peripheral side of the inner ring member 41 so as to face the inner ring member 41, and a plurality of balls 43 as rolling elements provided so as to be able to roll between the outer ring member 42 and the inner ring member 41.

Further, the first joint portion 4 is formed so that an outside diameter D3 of the outer ring member 42 is set to be larger than an outside diameter D1 of the first inserting portion 22. More specifically, the first joint portion 4 is formed so that when the first shaft portion 2 penetrates into the inside of the tube 1 upon collision of the vehicle at the front side, each head portion 60 of bolts 6, which are screwed into the first joint portion 4 from the tube 1 side and fastened to the first power transmission device, comes into contact with an end surface (a first end surface 112), located at the first end portion 11 side, of the tube 1.

At an inner peripheral side of the inner ring member 41, a substantially circular shaft penetration hole 411, which the first joint-side connecting portion 25 penetrates, penetrates the inner ring member 41 along the axial direction. That is, the first joint-side connecting portion 25 is press-fitted into the shaft penetration hole 411 throughout an almost entire axial area of the shaft penetration hole 411, and the first joint-side connecting portion 25 and the inner ring member 41 are fixed so as to be able to integrally rotate.

Further, inner ring-side axial direction grooves 412 in which the balls 43 can roll are formed along the axial direction at the outer peripheral side of the inner ring member 41. That is, the balls 43 roll between the inner ring-side axial direction grooves 412 and after-mentioned outer ring-side axial direction grooves 421, thereby allowing relative axial movement of the inner ring member 41 and the outer ring member 42, also, the balls 43 engage with the inner ring-side axial direction grooves 412 and the outer ring-side axial direction grooves 421, thereby restricting relative circumferential movement of the inner ring member 41 and the outer ring member 42.

The outer ring member 42 is fixed to the first power transmission device so as to be able to integrally rotate with the first power transmission device with the plurality of bolts 6 penetrating the outer ring member 42 in the axial direction. As mentioned above, the outer ring-side axial direction grooves 421 in which the balls 43 can roll are formed along the axial direction at an inner peripheral side of the outer ring member 42. That is, the balls 43 roll between the outer ring-side axial direction grooves 421 and the inner ring-side axial direction grooves 412, thereby allowing relative axial movement of the outer ring member 42 and the inner ring member 41, also, the balls 43 engage with the outer ring-side axial direction grooves 421 and the inner ring-side axial direction grooves 412, thereby restricting relative circumferential movement of the outer ring member 42 and the inner ring member 41.

With this configuration, the first power transmission device and the outer ring member 42 integrally rotate, thereby transmitting rotation torque output from the first power transmission device to the inner ring member 41 from the outer ring member 42 through the balls 43. Then, based on this transmitted rotation torque, the inner ring member 41 and the first shaft portion 2 (the first connecting base portion 21) integrally rotate.

The second shaft portion 3 has a second connecting base portion 31 exposed from the second end portion 12 of the tube 1 and connected to the second joint portion 5, and a second inserting portion 32 extending in the axial direction from a front end portion of the second connecting base portion 31 and inserted into the inner peripheral portion 121 of the second end portion 12 of the tube 1. The second connecting base portion 31 and the second inserting portion 32 are formed integrally with each other with a metal material.

The second connecting base portion 31 has a second base portion 33, a second insertion-side connecting portion 34 formed into a step shape whose diameter is widened from a front end portion of the second base portion 33 and connecting to the second inserting portion 32, and a second joint-side connecting portion 35 formed into a step shape whose diameter is widened from a rear end portion of the second base portion 33 and connecting to the second joint portion 5. Here, the second connecting base portion 31 and the second joint portion 5 form a second body portion of the present invention.

The second inserting portion 32 is inserted into the inner peripheral portion 121 of the second end portion 12 of the tube 1 through a predetermined engagement means (serrations in the present embodiment), and is fixed to the tube 1 so as to be able to rotate integrally with the tube 1. More specifically, a second serration part 36 that can be serration-connected to the tube 1 is formed throughout an almost entire area in the axial direction on an outer peripheral side of the second inserting portion 32.

The second serration part 36 is formed so that grooves 361 recessed inward in the radial direction are formed so as to extend in a direction parallel to the rotation axis Z, and an outside diameter D2 of each tooth tip 362 is set to be slightly larger than the inside diameter R1 of the tube 1. That is, the second inserting portion 32 is press-fitted into an inside of the second end portion 12 of the tube 1, and each tooth tip 362 bites into an inner peripheral surface of the tube 1, then the second serration part 36 makes the second inserting portion 32 engage with the tube 1 so as to be able to integrally rotate with the tube 1. With this, the second inserting portion 32 is supported in a fixed state at the inner peripheral portion 121 of the second end portion 12 of the tube 1 through the second serration part 36. Here, in the present embodiment, the outside diameter D2 of the tooth tip 362 of the second serration part 36 is set to be the same as the outside diameter D1 of the tooth tip 262 of the first serration part 26. In other words, a second biting amount X2 of the second serration part 36 is set to be the same as a first biting amount X1 of the first serration part 26.

Here, a second collision load F2, which releases the fixed state between the second inserting portion 32 and the tube 1 and causes the second inserting portion 32 to start moving from the second end portion 12 toward the first end portion 11 at the inner peripheral portion of the tube 1, is set between the second serration part 36 and the tube 1. Then, in the present embodiment, the second collision load F2 is set based on a second biting length L2 that is a biting length (a tooth width) of the second serration part 36 engaging with (biting into) the inner peripheral portion 121 of the second end portion 12 of the tube 1.

In the present embodiment, the second collision load F2 is set so as to be greater than the first collision load F1. That is, the second biting length L2 of the second serration part 36 is set so as to be longer than the first biting length L1 of the first serration part 26. In other words, the propeller shaft PS1 is configured so that before the second inserting portion 32 located at the second end portion 12 of the tube 1 starts moving from the second end portion 12 toward the first end portion 11, the first inserting portion 22 located at the first end portion 11 of the tube 1 starts moving from the first end portion 11 toward the second end portion 12. More specifically, the second biting length L2 of the second serration part 36 is set to approximately twice the first biting length L1 of the first serration part 26.

The second joint portion 5 is formed by a so-called rubber joint. The second joint portion 5 is provided at an opposite side to the tube 1 in the axial direction with respect to the second shaft portion 3. The second joint portion 5 is substantially annular in shape, and has three first bolt penetration holes 51 arranged at regular intervals in a circumferential direction of the second joint portion 5 and serving for connection to the second joint-side connecting portion 35 of the second shaft portion 3, and three second bolt penetration holes 52 arranged at regular intervals in the circumferential direction of the second joint portion 5 between the first bolt penetration holes 51 and serving for connection to the second power transmission device.

That is, the second joint-side connecting portion 35 formed into a trifurcated shape and the second joint portion 5 are connected with first bolts 61 penetrating the respective first bolt penetration holes 51, and are fixed so as to be able to integrally rotate. On the other hand, the second power transmission device formed into a trifurcated shape and the second joint portion 5 are connected with second bolts (not shown) penetrating the respective second bolt penetration holes 52, and are fixed so as to be able to integrally rotate.

Further, the second joint portion 5 is formed so that an outside diameter D4 of the second joint portion 5 is set to be larger than an outside diameter D2 of the second inserting portion 32. More specifically, the second joint portion 5 is formed so that when the second shaft portion 3 penetrates into the inside of the tube 1 upon collision of the vehicle at the rear side, an inner end surface 351 of the second joint-side connecting portion 35 can come into contact with an end surface (a second end surface 122), located at the second end portion 12 side, of the tube 1.

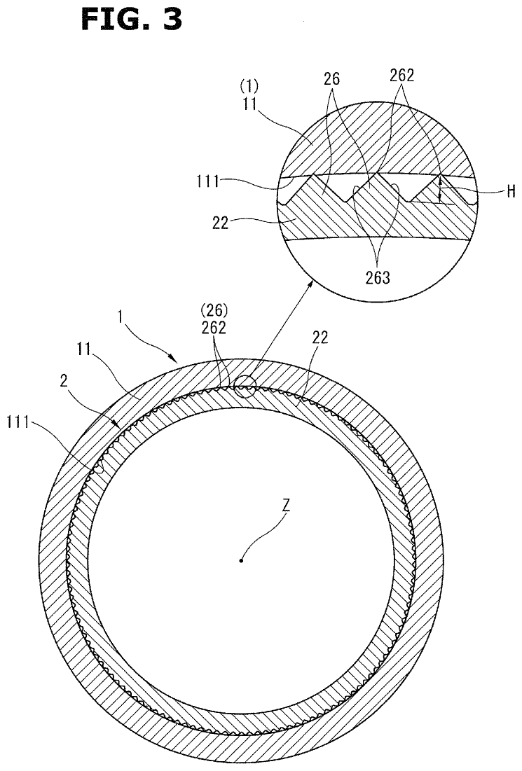

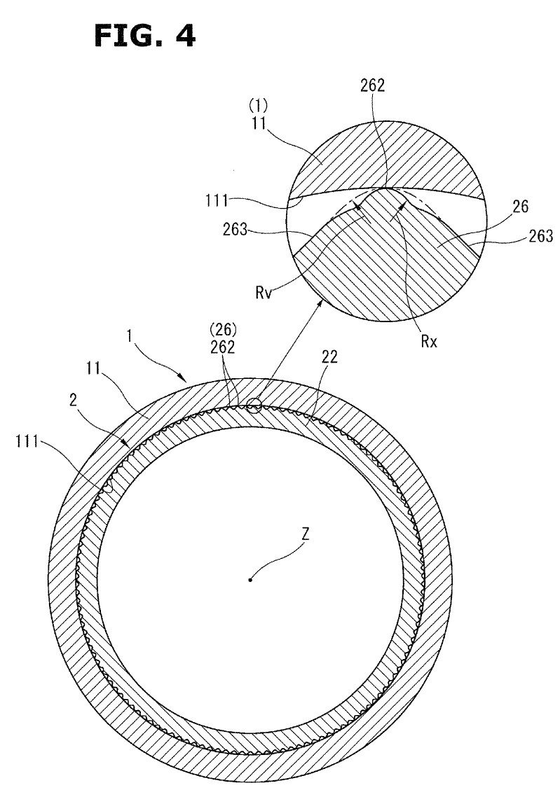

FIG. 3 is an enlarged sectional view of a main part of the propeller shaft PS1, cut by a plane A-A in FIG. 2. FIG. 4 is a modified example of the first serration part 26 shown in FIG. 3. It is noted that in the present embodiment, the first serration part 26 and the second serration part 36 differ only in the tooth width corresponding to the biting length L1, but a height H of the tooth tip 262 is the same. Therefore, for the sake of convenience, the first serration part 26 will be described as an example, and a detailed description of the second serration part 36 is omitted here.

As illustrated in FIG. 3, the tooth tip 262 of the first serration part 26 is formed into a sharp shape so as to be sharply pointed. With this shape, when the first inserting portion 22 is press-fitted into the first end portion 11 of the tube 1, the first inserting portion 22 is inserted into the inner peripheral portion 111 of the first end portion 11 of the tube 1 so that the sharply pointed tooth tip 262 shaves the inner peripheral portion 111 of the first end portion 11 of the tube 1 along the axial direction.

The first serration part 26 is not limited to the serration part having the shape of the sharply pointed tooth tip 262 shown in FIG. 3, but could be formed into a rounded arc shape as shown in FIG. 4. In this case, it is desirable that the tooth tip 262 of the first serration part 26 be formed by a round Rx that is smaller than a round Rv connecting a pair of tooth surfaces 263 of the first serration part 26. By setting the round Rx of the tooth tip 262 to be relatively small in this manner, a surface pressure of the tooth tip 262 when press-fitting the first inserting portion 22 into the tube 1 is increased, thereby ensuring good bite of the tooth tip 262 into the inner peripheral portion 111 of the tube 1.

### Collapse Structure of Propeller Shaft

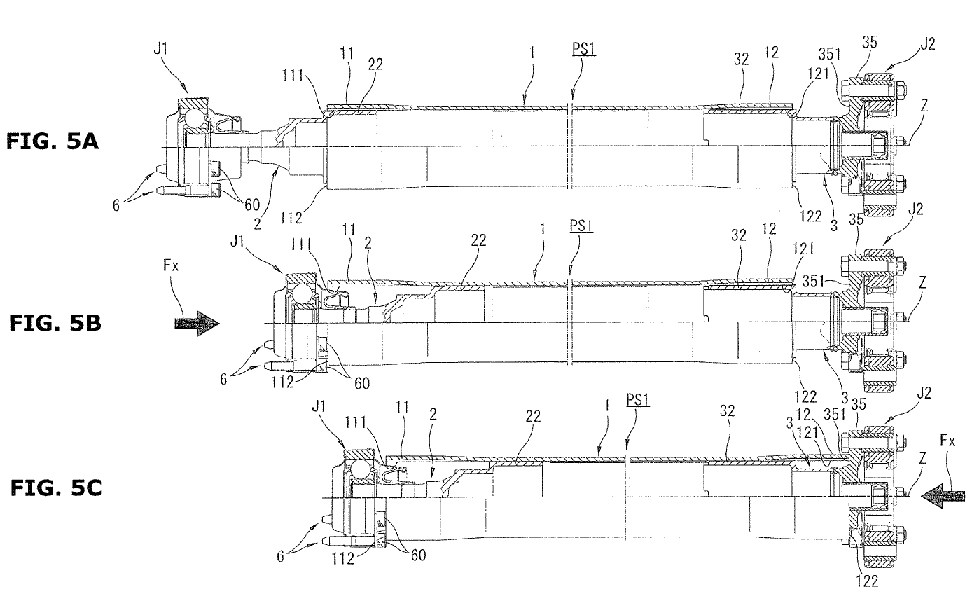

FIGS. 5A to 5C are longitudinal cross sections of the propeller shaft PS1 shown in FIG. 2, showing conditions of the propeller shaft PS1 before and after occurrence of collapse. FIG. 5A shows a condition of the power transmission shaft in which the collapse has not occurred. FIG. 5B shows a condition of the power transmission shaft in which the collapse has occurred at the first end portion 11 side of the tube 1. FIG. 5C shows a condition of the power transmission shaft in which the collapse has occurred at the second end portion 12 side of the tube 1.

In the following description, “collapse” means that the fixed state of the first inserting portion 22 and the second inserting portion 32 to the tube 1 is released (destroyed) by an input of an axial direction load Fx into the propeller shaft PS1, and the first shaft portion 2 (the first connecting base portion 21) and the second shaft portion 3 (the second connecting base portion 31) penetrate into the inside of the tube 1.

For instance, a case where the vehicle collides from the vehicle front and the axial direction load Fx in a compression direction which is greater than the second collision load F2 acts on the propeller shaft PS1 from a front end side of the propeller shaft PS1 will be described. This axial direction load Fx is transmitted from the first power transmission device (not shown) to the first shaft portion 2 through the first joint portion 4.

In the propeller shaft PS1 according to the present embodiment, since the first collision load F1 is set to be relatively smaller than the second collision load F2, first, the collapse occurs at the first end portion 11 side of the tube 1 from a normal condition shown in FIG. 5A. That is, as illustrated in FIG. 5B, between the first shaft portion 2 having received the axial direction load Fx that is greater than the first collision load F1 and the tube 1, the fixed state between the first inserting portion 22 and the tube 1 is released (destroyed), and the first connecting base portion 21 penetrates into the inside of the first end portion 11 of the tube 1. More specifically, at the first end portion 11 of the tube 1, the first inserting portion 22 moves from the first end portion 11 toward the second end portion 12 until the head portions 60 of the bolts 6 of the first joint portion 4 come into contact with the first end surface 112 of the tube 1.

Subsequently, in the propeller shaft PS1, the axial direction load Fx is transmitted from the first shaft portion 2 to the second shaft portion 3 through the tube 1, and by reaction to the second shaft portion 3 that is located (sandwiched) between the second power transmission device (not shown) and the tube 1, the axial direction load Fx acts on the second shaft portion 3 from the second power transmission device (not shown). Then, with a delay after the collapse at the first end portion 11 side, the collapse occurs at the second end portion 12 side of the tube 1. That is, as illustrated in FIG. 5C, between the second shaft portion 3 having received the axial direction load Fx that is greater than the second collision load F2 and the tube 1, the fixed state between the second inserting portion 32 and the tube 1 is released (destroyed), and the second connecting base portion 31 penetrates into the inside of the second end portion 12 of the tube 1. More specifically, at the second end portion 12 of the tube 1, the second inserting portion 32 moves from the second end portion 12 toward the first end portion 11 until the inner end surface 351 of the second joint-side connecting portion 35 comes into contact with the second end surface 122 of the tube 1.

As described above, in the present embodiment, a collapse state is controlled so that based on a magnitude relationship between the first collision load F1 and the second collision load F2, upon the action of the axial direction load Fx, the first end portion 11 side of the tube 1 is first destroyed, and after that, the second end portion 12 side of the tube 1 is destroyed. Then, by the collapse having occurred at the first end portion 11 side and the second end portion 12 side of the tube 1, the axial direction load Fx is buffered, and collision energy of the vehicle is absorbed. In other words, by the first connecting base portion 21 and the second connecting base portion 31 each penetrating into the inside of the tube 1 properly, the axial direction load Fx is buffered properly, then problem such as bending of the propeller shaft PS1 to a vehicle body side can be suppressed.

### Working and Effect of the Present Embodiment

In the case of the conventional propeller shaft, the first inserting portion and the second inserting portion having the first serration part and the second serration part which are the same shape are press-fitted into the first end portion and the second end portion of the FRP tube body respectively.

Because of this, when the vehicle collides, depending on processing errors of the FRP tube body and/or the first inserting portion and/or the second inserting portion, it is difficult to predict which of the first end portion and the second end portion of the FRP tube body is first destroyed, i.e. which of the first inserting portion and the second inserting portion first penetrates into the FRP tube body. Therefore, there is room for improvement in that collision performance of the propeller shaft becomes unstable.

In contrast to this, in the case of the propeller shaft PS1 according to the present embodiment, the following working and effects can be brought about, then the above technical problem of the conventional propeller shaft can be solved.

The propeller shaft PS1 is a power transmission shaft (a propeller shaft) transmitting power between a first power transmission device (not shown) and a second power transmission device (not shown) of a vehicle, comprising: a tube 1 formed into a tubular shape; a first joint member J1 having a first body portion (a first connecting base portion 21, a first joint portion 4) and a first inserting portion 22, wherein the first inserting portion 22 is formed so that an outer peripheral portion of the first inserting portion 22 is supported in a fixed state at an inner peripheral portion 111 of a first end portion 11 of the tube 1, which is one of a pair of end portions of the first end portion 11 and a second end portion 12 in a direction of a rotation axis Z of the tube 1, and a first collision load F1, which releases the fixed state between the first inserting portion 22 and the tube 1 and causes the first inserting portion 22 to start moving from the first end portion 11 toward the second end portion 12 of the tube 1, is set between the first inserting portion 22 and the tube 1, and wherein the first body portion (the first connecting base portion 21, the first joint portion 4) is provided at an opposite side to the first inserting portion 22 in the direction of the rotation axis Z with respect to the first end portion 11, and is connected to the first power transmission device (not shown) ; and a second joint member J2 having a second body portion (a second connecting base portion 31, a second joint portion 5) and a second inserting portion 32, wherein the second inserting portion 32 is formed so that an outer peripheral portion of the second inserting portion 32 is supported in a fixed state at an inner peripheral portion 121 of the second end portion 12 of the tube 1, and a second collision load F2, which releases the fixed state between the second inserting portion 32 and the tube 1 and causes the second inserting portion 32 to start moving from the second end portion 12 toward the first end portion 11 of the tube 1, is set between the second inserting portion 32 and the tube 1, and further, the second collision load (F2) is set to be greater than the first collision load (F1), and wherein the second body portion (the second connecting base portion 31, the second joint portion 5) is provided at an opposite side to the second inserting portion 32 in the direction of the rotation axis Z with respect to the second end portion 12, and is connected to the second power transmission device.

As described above, in the present embodiment, the propeller shaft PS1 is configured so that when the second collision load F2, which is greater than the first collision load F1 by which the fixed state between the first inserting portion 22 and the tube 1 is released, acts, the fixed state between the second inserting portion 32 and the tube 1 is released. Therefore, upon the collision of the vehicle, i.e. when the axial direction load Fx acts on the propeller shaft PS1, the fixed state of the first inserting portion 22 is released earlier than the second inserting portion 32. It is thus possible to control an order of the fixation release of the first inserting portion 22 and the second inserting portion 32 to the tube 1, thereby improving stability of the collision performance of the propeller shaft PS1.

Further, in the present embodiment, the tube 1 is made of a material formed by solidifying fiber with resin.

As described above, in the present embodiment, the tube 1 is made of the material formed by solidifying the fiber with the resin. Therefore, as compared with a case where the tube 1 is made of a metal material, the tube 1 can be lightened, thereby improving fuel efficiency.

In particular, in the present embodiment, the tube 1 is made of the carbon fiber reinforced resin material (the carbon fiber reinforced plastic) (CFRP).

As described above, in the present embodiment, since the tube 1 is made of the carbon fiber reinforced resin material (CFRP), as compared with a case where the tube 1 is made of other fiber reinforced resins, e.g. a glass fiber reinforced resin (glass fiber reinforced plastic) (FRP), strength of the tube 1 becomes high, and also the tube 1 can be further lightened.

Further, as another example of the present embodiment, as mentioned in the above description, the tube 1 could be made of the glass fiber reinforced resin (FRP). In this case, as compared with a case where the tube 1 is made of other fiber reinforced resins, e.g. the carbon fiber reinforced resin material (CFRP), the tube 1 can be formed at lower cost.

Furthermore, in the present embodiment, the first inserting portion 22 has, at the outer peripheral portion of the first inserting portion 22, a first serration part 26 that bites into an inner peripheral surface of the first end portion 11 of the tube 1, the first collision load F1 is set by a first biting length L1 along which the first serration part 26 bites into the inner peripheral surface of the first end portion 11 of the tube 1 in the direction of the rotation axis Z, the second inserting portion 32 has, at the outer peripheral portion of the second inserting portion 32, a second serration part 36 that bites into an inner peripheral surface of the second end portion 12 of the tube 1, the second collision load F2 is set by a second biting length L2 along which the second serration part 36 bites into the inner peripheral surface of the second end portion 12 of the tube 1 in the direction of the rotation axis Z, and the second biting length L2 is set to be longer than the first biting length L1.

As described above, in the present embodiment, by setting the second biting length L2 to be longer than the first biting length L1, the second collision load F2 is set to be greater than the first collision load F1. Therefore, as compared with a case, like the following second embodiment of the present invention, where by setting a biting amount (an after-described second biting amount X2) of the second inserting portion 32 with respect to the tube 1 to be greater than a biting amount (an after-described first biting amount X1) of the first inserting portion 22 with respect to the tube 1, the second collision load F2 is set to be greater than the first collision load F1, strength of the tube 1 can be ensured. In addition, control of the collision load of the propeller shaft PS1 becomes easy.

That is, in the case where the first collision load F1 and the second collision load F2 are controlled based on the biting amounts of the first inserting portion 22 and the second inserting portion 32, when setting the biting amounts of the first inserting portion 22 and the second inserting portion 32 to be great, the outside diameters of the first inserting portion 22 and the second inserting portion 32 become large. As a consequence, the first inserting portion 22 and the second inserting portion 32 greatly push and expand the first end portion 11 and the second end portion 12 of the tube 1, then this may cause reduction in strength of the tube 1. In contrast to this, in the case, like the present embodiment, where the first collision load F1 and the second collision load F2 are controlled based on the first biting length L1 and the second biting length L2, the outside diameters of the first inserting portion 22 and the second inserting portion 32 are not changed. Therefore, there is no risk of causing the reduction in strength of the tube 1. Further, since the outside diameters of the first inserting portion 22 and the second inserting portion 32 are not changed, there is no need to reconsider a strength design of the tube 1. Hence, as compared with the case where the first collision load F1 and the second collision load F2 are controlled based on the biting amounts of the first inserting portion 22 and the second inserting portion 32, as a merit, control of the first collision load F1 and the second collision load F2 can be relatively easily done.

Moreover, in the present embodiment, the first inserting portion 22 has, at the outer peripheral portion of the first inserting portion 22, a first serration part 26 that bites into an inner peripheral surface of the first end portion 11 of the tube 1, the second inserting portion 32 has, at the outer peripheral portion of the second inserting portion 32, a second serration part 36 that bites into an inner peripheral surface of the second end portion 12 of the tube 1, and a tip portion of at least either one of the first serration part 26 and the second serration part 36 is formed into a sharp shape when viewed from a cross section of the tube 1 which is orthogonal to the rotation axis Z.

As described above, in the present embodiment, the tip portion of at least either one of the first serration part 26 and the second serration part 36 is formed into the sharp shape when viewed from a cross section of the tube 1 which is orthogonal to the rotation axis Z of the tube 1. Since the tip portion of at least either one of the first serration part 26 and the second serration part 36 is formed into the sharp shape, the first serration part 26 and/or the second serration part 36 easily bite into the tube 1. Manufacturing workability of the propeller shaft PS1 is therefore improved, and productivity of the propeller shaft PS1 can be increased.

As the modified example of the present embodiment, as illustrated in FIG. 4, the first inserting portion 22 has, at the outer peripheral portion of the first inserting portion 22, a first serration part 26 that bites into an inner peripheral surface of the first end portion 11 of the tube 1, the second inserting portion 32 has, at the outer peripheral portion of the second inserting portion 32, a second serration part 36 that bites into an inner peripheral surface of the second end portion 12 of the tube 1, and a tip portion of at least either one of the first serration part 26 and the second serration part 36 is formed into an arc shape when viewed from a cross section of the tube 1 which is orthogonal to the rotation axis Z.

As described in this modified example, the tip portions of the first serration part 26 and/or the second serration part 36 are rounded, thereby suppressing occurrence of burrs when machining the first serration part 26 and/or the second serration part 36. Therefore, unintended increase in the collision load due to the burrs can be suppressed, thereby improving controllability of the collision load of the propeller shaft PS1.

Further, in the present embodiment, the first power transmission device (not shown) is the transmission TM, and the second power transmission device (not shown) is the differential gear DF.

As described above, in the present embodiment, the first collision load F1 of the first end portion 11 side of the tube 1 connected to the transmission TM that tends to be mounted on the front side of the vehicle is set to be relatively low. Since the vehicle usually collides from the vehicle front, by setting the collision load of the vehicle front side to be relatively low, safety can be improved.

### Second Embodiment

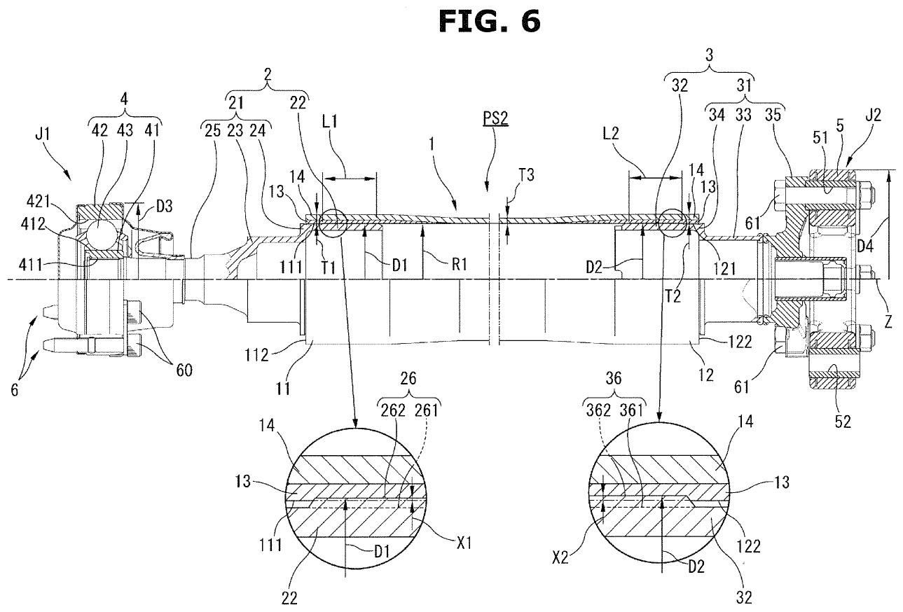

FIG. 6 shows a second embodiment of the power transmission shaft (the propeller shaft) according to the present invention, in which a configuration related to the first collision load F1 and the second collision load F2 of the propeller shaft PS1 according to the first embodiment is changed. Since a basic structure or configuration of the second embodiment except the changes is the same as that of the first embodiment, the same structure or configuration as that of the first embodiment is denoted by the same reference sign, and its detailed description is omitted here. In the following description of the present embodiment, for the sake of convenience, a first joint member J1 side in FIG. 6 is referred to as a “front”, and a second joint member J2 side is referred to as a “rear”. Further, a direction along a rotation axis Z in FIG. 6 is referred to as an “axial direction”, a direction orthogonal to the rotation axis Z is referred to as a “radial direction”, and a direction of rotation about the rotation axis Z is referred to as a “circumferential direction”.

### Configuration of Propeller Shaft

FIG. 6 shows an entire propeller shaft PS2 according to the second embodiment of the present invention. FIG. 6 is a longitudinal cross section of the propeller shaft PS2, cut along the direction of the rotation axis Z.

As illustrated in FIG. 6, the propeller shaft PS2 according to the present embodiment is formed so that the first biting length L1 of the first inserting portion 22 and the second biting length L2 of the second inserting portion 32 are the same. Further, at the first end portion 11 of the tube 1, the first collision load F1 is set based on the first biting amount X1 by which the first serration part 26 bites into the inner peripheral portion 111 of the first end portion 11 of the tube 1. Also, the second collision load F2 is set based on the second biting amount X2 by which the second serration part 36 bites into the inner peripheral portion 121 of the second end portion 12 of the tube 1. That is, the second biting amount X2 of the second serration part 36 is set to be greater than the first biting amount X1 of the first serration part 26. More specifically, the second biting amount X2 is set to approximately twice the first biting amount X1.

### Working and Effect of the Present Embodiment

As described above, in the propeller shaft PS2 according to the present embodiment, the first inserting portion 22 has, at the outer peripheral portion of the first inserting portion 22, a first serration part 26 that bites into an inner peripheral surface of the first end portion 11 of the tube 1, the first collision load F1 is set by a first biting amount X1 by which the first serration part 26 in the direction of the rotation axis Z bites into the inner peripheral surface of the first end portion 11 of the tube 1, the second inserting portion 32 has, at the outer peripheral portion of the second inserting portion 32, a second serration part 36 that bites into an inner peripheral surface of the second end portion 12 of the tube 1, the second collision load F2 is set by a second biting amount X2 by which the second serration part 36 in the direction of the rotation axis Z bites into the inner peripheral surface of the second end portion 12 of the tube 1, and the second biting amount X2 is set to be greater than the first biting amount X1.

As described above, in the present embodiment, by setting the second biting amount X2 to be greater than the first biting amount X1, the second collision load F2 is set to be greater than the first collision load F1. In this manner, in the present embodiment, by controlling the collision load by setting the second biting amount X2 of the second inserting portion 32 to be relatively greater than the first biting amount X1 of the first inserting portion 22, transmission of relatively large torque can be realized. Further, in the case where the collision load is controlled by setting the second biting amount X2 of the second inserting portion 32 to be relatively greater than the first biting amount X1 of the first inserting portion 22, the second inserting portion 32 can be shortened by setting the second biting length L2 of the second inserting portion 32 to be relatively short. Therefore, a manufacturing cost of the propeller shaft PS2 can be reduced.

### Third Embodiment

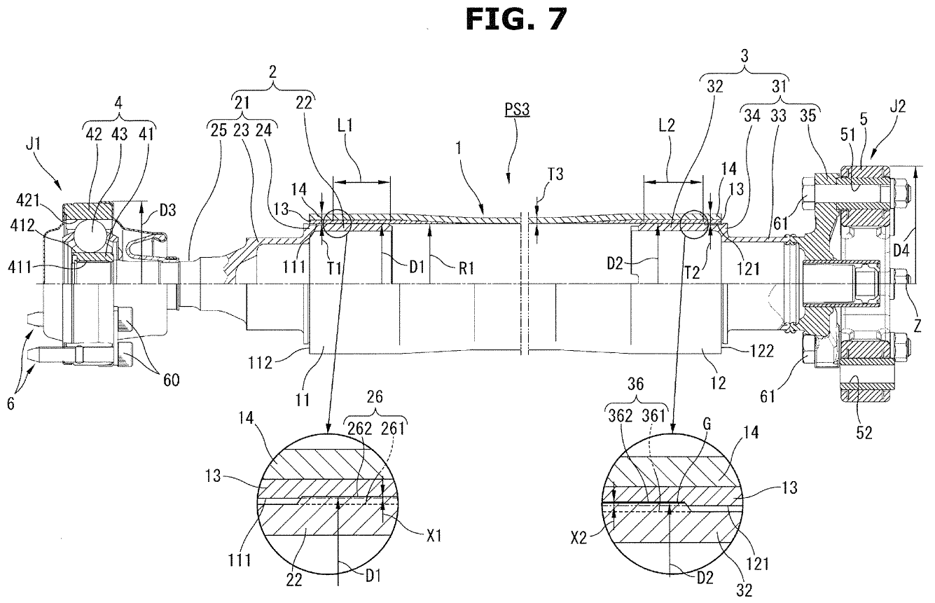

FIG. 7 shows a third embodiment of the power transmission shaft (the propeller shaft) according to the present invention, in which a configuration related to the first collision load F1 and the second collision load F2 of the propeller shaft PS1 according to the first embodiment is changed. Since a basic structure or configuration of the third embodiment except the changes is the same as that of the first embodiment, the same structure or configuration as that of the first embodiment is denoted by the same reference sign, and its detailed description is omitted here. In the following description of the present embodiment, for the sake of convenience, a first joint member J1 side in FIG. 7 is referred to as a “front”, and a second joint member J2 side is referred to as a “rear”. Further, a direction along a rotation axis Z in FIG. 7 is referred to as an “axial direction”, a direction orthogonal to the rotation axis Z is referred to as a “radial direction”, and a direction of rotation about the rotation axis Z is referred to as a “circumferential direction”.

### Configuration of Propeller Shaft

FIG. 7 shows an entire propeller shaft PS3 according to the third embodiment of the present invention. FIG. 7 is a longitudinal cross section of the propeller shaft PS3, cut along the direction of the rotation axis Z.

As illustrated in FIG. 7, the propeller shaft PS3 according to the present embodiment is formed so that the first biting length L1 of the first inserting portion 22 and the second biting length L2 of the second inserting portion 32 are the same. Further, at the first end portion 11 of the tube 1, the first serration part 26 bites into the inner peripheral surface of the first end portion 11 of the tube 1, then the first inserting portion 22 is supported in the fixed state at the first end portion 11 of the tube 1. On the other hand, at the second end portion 12 of the tube 1, the second serration part 36 bites into the inner peripheral surface of the second end portion 12 of the tube 1, and also the second serration part 36 and the inner peripheral surface of the second end portion 12 of the tube 1 are bonded with an adhesive G, then the second inserting portion 32 is supported in the fixed state at the second end portion 12 of the tube 1. With this configuration, in the present embodiment, the first collision load F1 is set based on the first biting length L1 of the first serration part 26, whereas the second collision load F2 is set based on the second biting length L2 of the second serration part 36 and adhesion (an adhesive strength or an adhesive force) of the adhesive G. With this, the second collision load F2 is set to be greater than the first collision load F1.

### Working and Effect of the Present Embodiment

As described above, in the propeller shaft PS3 according to the present embodiment, the first inserting portion 22 has, at the outer peripheral portion of the first inserting portion 22, a first serration part 26 that bites into an inner peripheral surface of the first end portion 11 of the tube 1, the second inserting portion 32 has, at the outer peripheral portion of the second inserting portion 32, a second serration part 36 that bites into an inner peripheral surface of the second end portion 12 of the tube 1, and the second serration part 36 and the tube 1 are bonded with an adhesive G.

As described above, in the present embodiment, by bonding the second serration part 36 and the tube 1 with the adhesive G, the second collision load F2 is set to be greater than the first collision load F1. In this manner, by controlling the collision load so that the second collision load F2 is relatively great by applying the adhesive G to the second serration part 36, no precise machining of the first serration part 26 and the second serration part 36 is required. In other words, even if machining accuracy of the first serration part 26 and the second serration part 36 is relatively low, the second collision load F2 can be secured by the adhesion of the adhesive G. With this, a manufacturing cost of the propeller shaft PS3 can be reduced.

### Fourth Embodiment

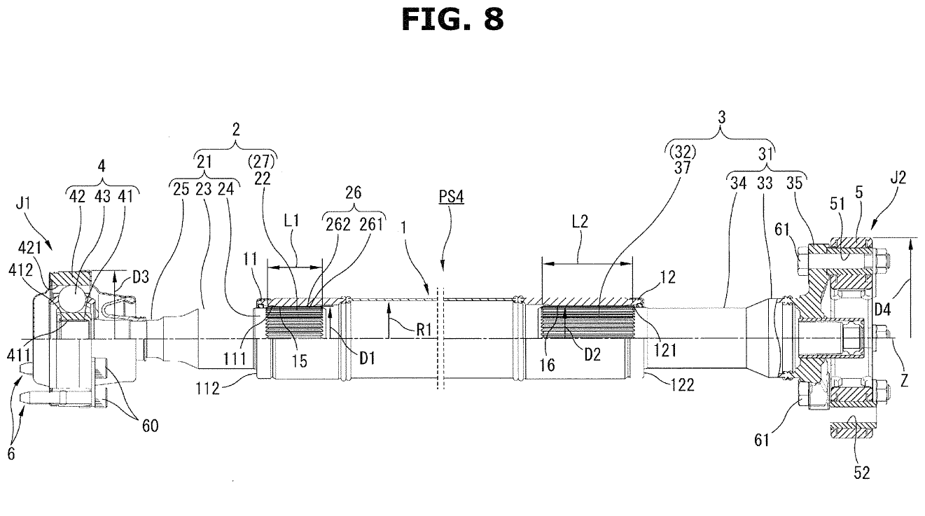

FIG. 8 shows a fourth embodiment of the power transmission shaft (the propeller shaft) according to the present invention, in which a configuration related to the first collision load F1 and the second collision load F2 of the propeller shaft PS1 according to the first embodiment is changed. Since a basic structure or configuration of the fourth embodiment except the changes is the same as that of the first embodiment, the same structure or configuration as that of the first embodiment is denoted by the same reference sign, and its detailed description is omitted here. In the following description of the present embodiment, for the sake of convenience, a first joint member J1 side in FIG. 8 is referred to as a “front”, and a second joint member J2 side is referred to as a “rear”. Further, a direction along a rotation axis Z in FIG. 8 is referred to as an “axial direction”, a direction orthogonal to the rotation axis Z is referred to as a “radial direction”, and a direction of rotation about the rotation axis Z is referred to as a “circumferential direction”.

### Configuration of Propeller Shaft

FIG. 8 shows an entire propeller shaft PS4 according to the fourth embodiment of the present invention. FIG. 8 is a longitudinal cross section of the propeller shaft PS4, cut along the direction of the rotation axis Z.

As illustrated in FIG. 8, the tube 1 of the propeller shaft PS4 according to the present embodiment is made of a metal material. Further, in the propeller shaft PS4, the first inserting portion 22 is spline-connected to the first end portion 11 of the tube 1, and the second inserting portion 32 is spline-connected to the second end portion 12 of the tube 1.

That is, a first female spline portion 15 extending along the axial direction is formed at the inner peripheral portion 111 of the first end portion 11 of the tube 1. Likewise, a second female spline portion 16 extending along the axial direction is formed at the inner peripheral portion 121 of the second end portion 12 of the tube 1.

Further, a first male spline portion 27 engaging with the first female spline portion 15 and being movable in the axial direction along the first female spline portion 15 is formed at the outer peripheral portion of the first inserting portion 22 of the tube 1. Then, the first inserting portion 22 is press-fitted into the first female spline portion 15 of the tube 1 through the first male spline portion 27. Likewise, a second male spline portion 37 engaging with the second female spline portion 16 and being movable in the axial direction along the second female spline portion 16 is formed at the outer peripheral portion of the second inserting portion 32 of the tube 1. Then, the second inserting portion 32 is press-fitted into the second female spline portion 16 of the tube 1 through the second male spline portion 37.

Then, the first collision load F1 is set by the first biting length L1 along which the first female spline portion 15 engages with the first male spline portion 27. On the other hand, the second collision load F2 is set by the second biting length L2 along which the second female spline portion 16 engages with the second male spline portion 37. Further, in the present embodiment, the second biting length L2 is set to be longer than the first biting length L1.

Here, in the present embodiment, a case where the first collision load F1 is set by the first biting length L1 and the second collision load F2 is set by the second biting length L2 has been exemplified. However, as in the second embodiment, the first collision load F1 may be set by the first biting amount X1, and the second collision load F2 may be set by the second biting amount X2. Also, as in the third embodiment, the second female spline portion 16 and the second male spline portion 37 may be bonded with the adhesive G.

### Working and Effect of the Present Embodiment

As described above, in the propeller shaft PS4 according to the present embodiment, a first female spline portion 15 is formed at the inner peripheral portion 111 of the first end portion 11 of the tube 1, a first male spline portion 27 engaging with the first female spline portion 15 and being movable in the direction of the rotation axis Z is formed at the outer peripheral portion of the first inserting portion 22, the outer peripheral portion of the first inserting portion 22 is press-fitted into the inner peripheral portion 111 of the first end portion 11 of the tube 1, a second female spline portion 16 is formed at the inner peripheral portion 121 of the second end portion 12 of the tube 1, a second male spline portion 37 engaging with the second female spline portion 16 and being movable in the direction of the rotation axis Z is formed at the outer peripheral portion of the second inserting portion 32, and the outer peripheral portion of the second inserting portion 32 is press-fitted into the inner peripheral portion 121 of the second end portion 12 of the tube 1.

As described above, in the present embodiment, the tube 1 and the first inserting portion 22 and also the tube 1 and the second inserting portion 32 are each connected through the respective splines. Therefore, unlike the above first, second and third embodiments, the tube 1 can be made of an iron-based metal. Thus, as compared with a case where the tube 1 is made of the fiber reinforced resin, the propeller shaft PS4 can be manufactured at a relatively low cost.

### Fifth Embodiment

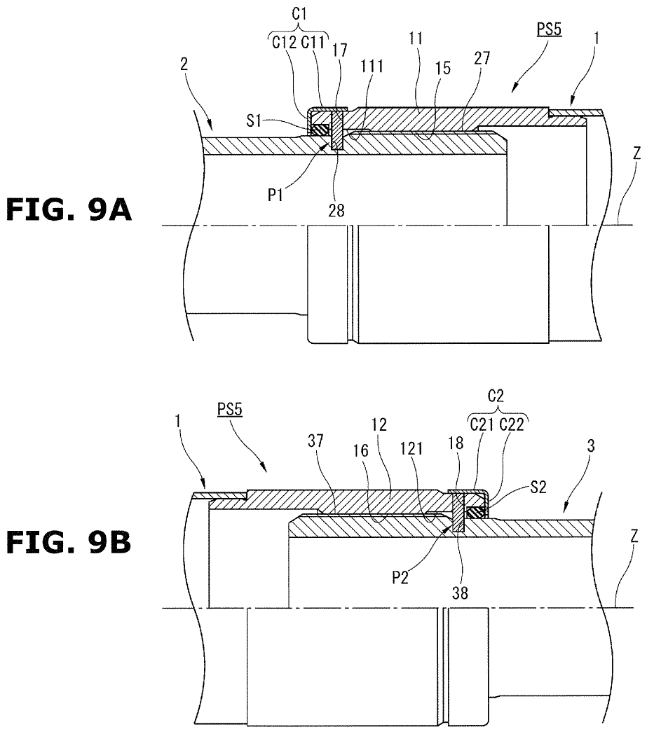

FIG. 9 shows a fifth embodiment of the power transmission shaft (the propeller shaft) according to the present invention, in which a configuration related to the first collision load F1 and the second collision load F2 of the propeller shaft PS4 according to the fourth embodiment is changed. Since a basic structure or configuration of the fifth embodiment except the changes is the same as that of the fourth embodiment, the same structure or configuration as that of the fourth embodiment is denoted by the same reference sign, and its detailed description is omitted here. In the following description of the present embodiment, for the sake of convenience, a left side in FIG. 9 is referred to as a “front”, and a right side is referred to as a “rear”. Further, a direction along a rotation axis Z in FIG. 9 is referred to as an “axial direction”, a direction orthogonal to the rotation axis Z is referred to as a “radial direction”, and a direction of rotation about the rotation axis Z is referred to as a “circumferential direction”.

### Configuration of Propeller Shaft

FIGS. 9A and 9B are longitudinal cross sections of the propeller shaft PS5 according to the fifth embodiment of the present invention, cut along the direction of the rotation axis Z. FIG. 9A is an enlarged view of a vicinity of the first end portion 11 of the tube 1. FIG. 9B is an enlarged view of a vicinity of the second end portion 12 of the tube 1.

That is, as illustrated in FIG. 9A, in the propeller shaft PS5 according to the present embodiment, a first pin through hole 17 which a substantially cylindrical columnar first pin P1 can penetrate is formed along the radial direction at the first end portion 11 of the tube 1. On the other hand, at the first inserting portion 22, a first pin insertion hole 28 into which the first pin P1 can be inserted is formed at a position facing the first pin through hole 17 in the radial direction. Then, by press-fitting the first pin P1 from the first pin through hole 17 side so as to reach from the first pin through hole 17 to the first pin insertion hole 28, the first inserting portion 22 is supported in the fixed state at the first end portion 11 of the tube 1. In the present embodiment, the first collision load F1 is set by a break strength of the first pin P1.

Further, at an opening end portion of the first end portion 11 of the tube 1, a first seal member S1 is disposed between the inner peripheral portion 111 of the first end portion 11 and the outer peripheral portion of the first inserting portion 22 of the first shaft portion 2 at an outer position with respect to the first pin P1. The first seal member S1 liquid-tightly seals a first gap formed between the inner peripheral portion 111 of the first end portion 11 and the outer peripheral portion of the first inserting portion 22 of the first shaft portion 2 at the first end portion 11 of the tube 1, thereby preventing moisture and foreign matter from entering through the first gap.

In addition, a substantially annular first cover member C1 having an L-shape in longitudinal cross section is fixed to an outer peripheral edge portion of the first end portion 11 of the tube 1 by swaging or crimping. The first cover member C1 prevents the first pin P1 from falling off by a first outer peripheral portion C11 covering the outer peripheral side of the tube 1 and facing the first pin P1 in the radial direction. Also, the first cover member C1 prevents the first seal member S1 from falling off by a first axial direction end surface C12 covering the first end surface 112 of the tube 1 and facing the first seal member S1 in the radial direction.

Likewise, as illustrated in FIG. 9B, in the propeller shaft PS5 according to the present embodiment, a second pin through hole 18 which a substantially cylindrical columnar second pin P2 can penetrate is formed along the radial direction at the end portion 12 of the tube 1. On the other hand, at the second inserting portion 32, a second pin insertion hole 38 into which the second pin P2 can be inserted is formed at a position facing the second pin through hole 18 in the radial direction. Then, by press-fitting the second pin P2 from the second pin through hole 18 side so as to reach from the second pin through hole 18 to the second pin insertion hole 38, the second inserting portion 32 is supported in the fixed state at the end portion 12 of the tube 1. In the present embodiment, the second collision load F2 is set by a break strength of the second pin P2. That is, by setting the break strength of the second pin P2 to be greater than the break strength of the first pin P1, e.g. by setting an outside diameter of the second pin P2 to be relatively larger than an outside diameter of the first pin P1, the second collision load F2 is set so as to be greater than the first collision load F1.

Further, at an opening end portion of the end portion 12 of the tube 1, a second seal member S2 is disposed between the inner peripheral portion 121 of the second end portion 12 and the outer peripheral portion of the second inserting portion 32 of the second shaft portion 3 at an outer position with respect to the second pin P2. The second seal member S2 liquid-tightly seals a second gap formed between the inner peripheral portion 121 of the second end portion 12 and the outer peripheral portion of the second inserting portion 32 of the second shaft portion 3 at the second end portion 12 of the tube 1, thereby preventing moisture and foreign matter from entering through the second gap.

In addition, a substantially annular second cover member C2 having an L-shape in longitudinal cross section is fixed to an outer peripheral edge portion of the second end portion 12 of the tube 1 by swaging or crimping. The second cover member C2 prevents the second pin P2 from falling off by a second outer peripheral portion C21 covering the outer peripheral side of the tube 1 and facing the second pin P2 in the radial direction. Also, the second cover member C2 prevents the second seal member S2 from falling off by a second axial direction end surface C22 covering the second end surface 122 of the tube 1 and facing the second seal member S2 in the radial direction.

### Working and Effect of the Present Embodiment

As described above, in the propeller shaft PS5 according to the present embodiment, a first pin hole (a first pin through hole 17, a first pin insertion hole 28) into which a first pin P1 can be inserted so as to reach from the first end portion 11 of the tube 1 to the first inserting portion 22 in a radial direction is formed at the first end portion 11 of the tube 1 and the first inserting portion 22, a second pin hole (a second pin through hole 18, a second pin insertion hole 38) into which a second pin P2 can be inserted so as to reach from the second end portion 12 of the tube 1 to the second inserting portion 32 in the radial direction is formed at the second end portion 12 of the tube 1 and the second inserting portion 32, and a break strength of the second pin P2 is greater than a break strength of the first pin P1.

As described above, in the present embodiment, the tube 1 and the first inserting portion 22 and also the tube 1 and the second inserting portion 32 are each connected through the first pin P1 and the second pin P2 respectively. Therefore, except for the first pin P1 and the second pin P2 which are related to the setting of the first collision load F1 and the second collision load F2, it is possible to share components of a conventional propeller shaft formed by spline-connecting the first joint member J1 and the second joint member J2 to the both end portions of the tube 1. With this, a manufacturing cost of the propeller shaft PS5 can be reduced. Further, since the collision load is controlled only by a connecting means by the first pin P1 and the second pin P2, as compared with other connecting means such as the serration like the first embodiment, as a merit, control of the collision load becomes relatively easy.

The present invention is not limited to the configurations or structures exemplified in the above embodiments. As long as the above-described working and effect of the present invention can be obtained, the present invention can be freely changed according to specification, cost etc. of objects to which the present invention is applied.

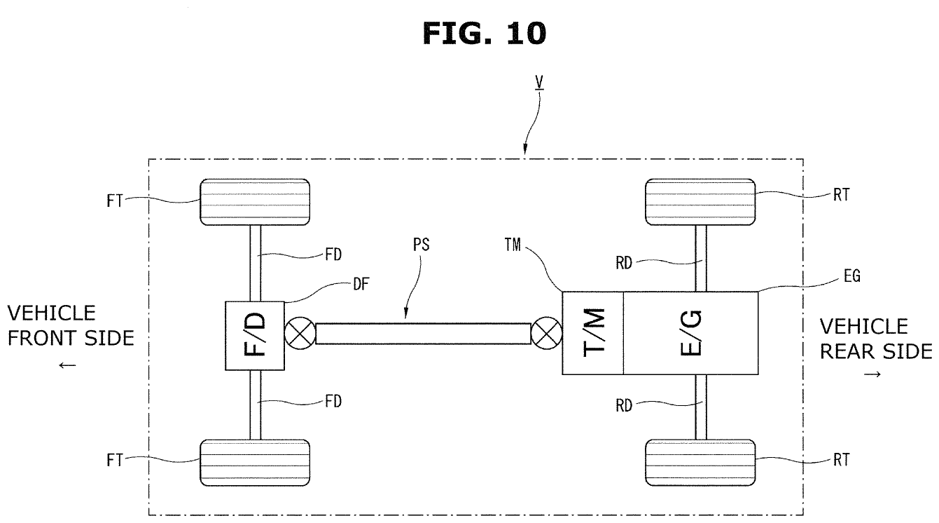

For instance, in each of the above embodiments, the case where the first power transmission device (not shown) is the transmission TM mounted on the vehicle and the second power transmission device (not shown) is the differential gear DF mounted on the vehicle is exemplified. However, as illustrated in FIG. 10, an opposite configuration to that of the above embodiments is possible. More specifically, the present invention can also be applied to, for instance, a vehicle having a rear-engine/all-wheel drive system and a vehicle having a drive system in which an engine EG and a transmission TM are mounted on a vehicle rear side and a driving force of the engine EG, output through the transmission TM, is transmitted to a differential gear DF mounted on a vehicle front side by a propeller shaft PS. That is, the first power transmission device (not shown) could be the differential gear DF, and the second power transmission device (not shown) could be the transmission TM.

According to this modified example, the first collision load F1 at the first end portion 11 side of the tube 1 connected to the transmission TM mounted on the relatively rear side of the vehicle is set to be relatively low. By setting the collision load at the vehicle rear side to be relatively low in this manner, as a merit, safety when the vehicle collides from the vehicle rear side can be improved.

Further, in the case where the transmission TM is provided at the driving wheel (rear wheel) side, for instance, the first power transmission device (not shown) may be a driving source such as the engine, and the second power transmission device (not shown) may be the transmission TM. In addition, its opposite is also possible.

Additionally, the present invention can also be applied to a vehicle in which as the first power transmission device (not shown), an electric motor as a continuously variable reduction gear instead of the transmission TM is used.

Moreover, as in each of the above embodiments, controlling the first collision load F1 and the second collision load F2 by the first biting length L1 and the second biting length L2, the first biting amount X1 and the second biting amount X2, the adhesive G and the pin P in the present invention is effective especially when an end portion at the first connecting base portion 21 side of the first inserting portion 22 and an end portion at the second connecting base portion 31 side of the second inserting portion 32 each do not have a flange portion. In other words, in a case where the flange portion is formed at the end portion at the first connecting base portion 21 side of the first inserting portion 22 and the end portion at the second connecting base portion 31 side of the second inserting portion 32, the first collision load F1 and the second collision load F2 may be controlled by e.g. an outside diameter of each flange.

1.-14. (canceled)

15. A power transmission shaft transmitting power between a first power transmission device and a second power transmission device of a vehicle, comprising:
a tube formed into a tubular shape;
a first joint member having a first body portion and a first inserting portion,
wherein the first inserting portion is fixed to an inner peripheral portion of a first end portion of the tube, which is one of a pair of end portions of the first end portion and a second end portion in a direction of a rotation axis of the tube, by a fact that a first serration part provided at an outer peripheral portion of the first inserting portion bites into the inner peripheral portion of a the first end portion of the tube at a first biting length,
wherein a first collision load, which releases a fixed state between the first inserting portion and the tube and causes the first inserting portion to start moving from the first end portion toward the second end portion of the tube, is set between the first inserting portion and the tube by the first biting length, and
wherein the first body portion is provided at an opposite side to the first inserting portion in the direction of the rotation axis with respect to the first end portion, and is connected to the first power transmission device; and
a second joint member having a second body portion and a second inserting portion,
wherein the second inserting portion is fixed to an inner peripheral portion of the second end portion of the tube by a fact that a second serration part provided at an outer peripheral portion of the second inserting portion bites into the inner peripheral portion of the second end portion of the tube at a second biting length,
wherein a second collision load, which releases a fixed state between the second inserting portion and the tube and causes the second inserting portion to start moving from the second end portion toward the first end portion of the tube, is set between the second inserting portion and the tube by the second biting length, and further, the second collision load is set to be greater than the first collision load, and
wherein the second body portion is provided at an opposite side to the second inserting portion in the direction of the rotation axis with respect to the second end portion, and is connected to the second power transmission device.

16. The power transmission shaft as claimed in claim 15, wherein
the tube is made of a material formed by solidifying fiber with resin.

17. The power transmission shaft as claimed in claim 16, wherein
the second serration part and the tube are bonded with an adhesive.

18. The power transmission shaft as claimed in claim 16, wherein
a tip portion of at least either one of the first serration part and the second serration part is formed into a sharp shape when viewed from a cross section of the tube which is orthogonal to the rotation axis.

19. The power transmission shaft as claimed in claim 16, wherein
a tip portion of at least either one of the first serration part and the second serration part is formed into an arc shape when viewed from a cross section of the tube which is orthogonal to the rotation axis.

20. The power transmission shaft as claimed in claim 16, wherein
the fiber is carbon fiber.

21. The power transmission shaft as claimed in claim 16, wherein
the fiber is glass fiber.

22. The power transmission shaft as claimed in claim 15, wherein
the first power transmission device is a transmission, and
the second power transmission device is a differential gear.

23. The power transmission shaft as claimed in claim 15, wherein
the first power transmission device is a differential gear, and
the second power transmission device is a transmission.
